(19) United States
(12) Patent Application Publication
(10) Pub. No.: US 2022/0379375 A1
(43) Pub. Date: Dec. 1, 2022

(54) Surface Modified Metallic Particulate In Sintered Products

(71) Applicant: Tundra Composites, LLC, White Bear Lake, MN (US)

(72) Inventor: Kurt Heikkila, Marine on the Saint Croix, MN (US)

(73) Assignee: Tundra Composites LLC, White Bear Lake, MN (US)

(21) Appl. No.: 17/879,445

(22) Filed: Aug. 2, 2022

Related U.S. Application Data
(63) Continuation of application No. 16/616,239, filed on Nov. 22, 2019.
(60) Provisional application No. 62/514,114, filed on Jun. 2, 2017.

(51) Int. Cl. B22F 3/22; B22F 1/05; B22F 1/17

(52) U.S. Cl. CPC B22F 3/225; B22F 1/05; B22F 1/17; B22F 2303/30; B22F 2304/10; B22F 2201/01; B22F 2301/35

(57) ABSTRACT

Disclosed are interfacially modified metal particulate composite materials for use in powder metallurgy sintered products and processes.

### FIELD

An interfacially modified metal particulate forms a composite material that can be used in forming a sintered structural article or object. An interfacially modified particulate can be dispersed in a polymer to form a composite material that can also be used in forming a sintered structural object. The modified particulate is first formed into a green body using a variety of forming processes. The green body is sintered into a final product.

### BACKGROUND

Metal particulate/powders can be used in injection molding, in press and sinter and in metal injection molding (MIM) processes. Recent developments include the utility of new materials and manufacturing techniques. For example, injection molding uses a variety of inorganic and metallic powders as a raw material from which a variety of product shapes and parts can be made. Precise shapes that perform uses in many commercial and consumer-based products have been made. Applications include automotive applications, aerospace applications, consumer durable goods, computer applications, medical applications and others. Inorganic and/or metal powders are consolidated or densified into specific shapes through several different production processes.

In general, powder injection molded products are made by obtaining raw materials, such as inorganic, ceramic or elemental or alloy metal powders. These powders can be combined with resins, waxes, graphite, dyes or lubricants, which can be mixed and then formed into an initial shape. Typically, the initially formed shaped material is sintered during the hot compaction stage or after the cold compaction stage to obtain a shaped inorganic or metal object. After initial processing, finishing steps including machining, heat treatment, steam treatment, composite formation, plating, etc. can be used in forming a final finished product. Processing such as Press and Sinter and MIM forming can reduce cost and produce a wide variety of simple and complex finished products in low cost processing techniques. Particle and polymer mixtures, in which a finely divided powder (about 40±10 microns) is dispersed, have been suggested for MIM. Catamold®, a BASF product, is a material for metal and ceramic injection molding based on polyacetal resin combined with stainless steels, special alloys or ceramics. U.S. Pat. No. 7,153,594 B2, Kejzelman et. al., discloses organic coatings and lubricants for ferromagnetic compounds without dispersion in a polymer.

A substantial need for the improvement of sintering processing such as Press and Sinter and MIM forming and both the products and the processes of forming or compaction in leading first to a green body and ultimately to a sintered product. The feedstock of the powder material is often difficult to mold and/or process due to the materials lack of viscoelastic properties, such as flow characteristics, physical and mechanical properties, and lack of self-ordering and packing of particle fractions. In certain instances, the products made with MIM, Press and Sinter etc. processes often do not have the commercially effective appearance or physical properties for many applications. Often, the formed objects, green body, have defects such as an absence of green strength, gravitational distortion resistance, density, or other needed properties because of insufficient particle packing and subsequent inefficient particle bonding. Further, the energy required to initially conform or eject the particulate mass to a shape such that the shape is complete and well-formed is excessive. The machines that initially form or compact the objects require high pressures, do not uniformly or fully fill, the whole space with powder resulting in a malformed part or unit. We have also found that the common commercial processes are not capable of forming commercially useful articles with a major dimension of greater than about 15 centimeters (cm).

A substantial need exists to improve metal powder molding techniques such that the processes are improved, the energy to form the part is reduced and the part formed in the process is complete without the malformations.

### BRIEF DESCRIPTION

We have found that a metal particulate with a coating of an interfacial modifier (IM) can be formed and sintered into an article. The IM has a dual function. The IM helps form the green body and improve green aspects such as packing. Once formed the green body can be sintered into a final product in which the IM cooperates to form a unique bonding between particles. The coated particulate can also be combined with a thermoplastic polymer and result in a particulate/polymer composite green body with green strength, high particle packing fractions and viscoelastic properties, such as melt flow, in a green body. These techniques form a green body that can be readily formed into a useful stiff, strong, bonded product or structural article via sintering to form a polymer free product with a unique particle/particle bonding structure and enhanced properties.

The sintered particle/particle bond includes combinations of atoms of at least one element from each particle surface in a bond structure with non-volatile and bonding atoms from the interfacial modifier (IM). In this context, “non-volatile” is determined at or near the used sintering temperature of the material. In sintering, substantially all organics, including organic components of the interfacial modifier (IM) and polymer or resin, are volatilized and are removed from the green body. In sintering, atoms from the particle surfaces migrate or diffuse from adjacent particle to particle and combine with non-volatile atoms remaining from the interfacial modifier (IM) to form a unique bonding at surface contact points. The nonvolatile portion of the IM becomes a part of the bonding between surfaces, and simply modifies the surface where it is not cooperating in a bonding between particles. The particles after sintering have the nonvolatile portions on the particle surface but the interior of the particle is substantially free of the IM and its components.

The bond structure includes a combination of metal atoms from the particles surfaces and metal atoms from the interfacial modifier. As IM and polymer organics are thermally removed from the green body, atoms from the particle surfaces migrate or diffuse from particle to particle and combine with atoms remaining from the interfacial modifier that in turn diffuse to form a unique bonding structure at particle surface contact points. In sintering, substantially all organics including organic components of the interfacial modifier (IM) and polymer or resin are volatilized and are removed from the green body. In sintering, atoms from adjacent particle surfaces migrate or diffuse from particle to particle and combine with atoms remaining from the interfacial modifier (IM) to form unique bonding at particle surface contact points. The articles can be made into complex shapes, articles with a major dimension greater than 15 cm.

During sintering, the presence of the nonvolatile portions of the IM can affect changes in the properties of the metal in the final shaped article. Such changed or improved properties include hardness, toughness, luster, corrosion resistance, malleability, ductility, density, tensile properties and modulus.

The term “green body” indicates a molded article comprising at least an IM coated particle and optionally a polymer component prior to sintering. The term “green shaped article” indicates an article comprising at least the IM coated particulate in a defined shape, optionally with a polymer phase prior to sintering. The term “brown body” refers to an intermediate stage between the “green” body and the final shaped or sintered article. The green body is heated to temperature sufficient to remove a portion of the volatiles such as organic components of the IM and optionally the polymer component. The brown body stage is inherent in the sintering step wherein the green body is converted to a final sintered article. As the sintering temperature of the green body is increased, the volatiles will slowly be removed, and the article will pass through a “brown body” stage.

The term “green strength” indicates the nature of the property or product when initially formed in a molding processing prior to being heated or sintered to form the final shaped article.

The term “green strength resistance to gravitational distortion” indicates the resistance of the product when initially molded to product dimensional distortion in the “green shaped article” due to gravity forces after molding but before sintering.

The term “final shaped article” or “final sintered article” as used in this disclosure refers to the final product of the process. A final product containing metal particles and the unique bonding scheme is made by first forming a green product and then sintering or heating the green product until it forms the unique particle-to-particle bonding resulting in the final product shape. In the final shaped article, after sintering each modified particle surface is bonded to at least one other modified particle surface at a particle to particle bond comprising a combination of the metal of each particle and the metal of the organo metallic interfacial modifier. Articles can have a complex form or can have a major dimension greater than 15 cm or greater than 20 cm.

The term “particle” refers to a single unit of a particulate. The term “particulate” refers to a collection of finely divided particles. The particulate has a range of types, sizes and morphologies. The maximum particle size is less than 500 microns. In referring to particle sizes, the term “D₅₀ less than 500 micron” means that 50 wt. % of the particulate is less than 500 microns. Similarly, the term “Do of 10 to 100 microns” means that 90 wt. % of the particulate is between 10 and 100 microns. Maximum particle size refers to the longest dimension of the particle. The particulate, coated with interfacial modifier, can be dispersed into a thermoplastic polymer. A formed body containing the interfacially modified particulate is sintered at elevated temperature to form a desired object. In the particulate or the interfacial modifier, the term “element” refers to an element of the periodic table of elements.

The “packing density” is a measure of the density of the packed particle compared to the density of the material.

In the particulate or the interfacial modifier, the term “element” refers to an element of the periodic table of elements.

The term “modified particle surface” refers to the presence of the IM on the particle surface or the presence of non-volatile components of the IM in the bonding area on the adjacent particle surfaces after sintering.

The term “coating” refers to any material added to the surface of a particle, which can be but is not necessarily continuous. The interfacial modifier coating can be substantial or continuous. After sintering, the remaining non-volatile metal from the interfacial modifier can be non-continuous.

The term “sinter” refers to a process in which a particulate is heated, optionally with pressure applied, to a temperature that causes particle to particle binding to form a solid. In a sinter process the particle itself does not melt but the energy of surface atoms on the particle causes atomic migration or diffusion among or between adjacent particles to form bonds that cause a solidification. In the claimed sintering, the temperature is sufficient to bond particles, to drive off all organic polymer materials and organic components of the interfacial modifiers but not so high as to liquefy the particulate. During the claimed sintering, the non-volatile or metal component of the interfacial modifier remains as a surface distribution, component or coating on a particle derived from the interfacial modifier after heating and aids in particle bonding.

The term “elevated temperature” refers to a temperature sufficient for thermal process to cause the temperature driven particle surface bonding or removal of organic materials such as interfacial modifier moieties and polymeric materials. Such temperatures can be used in “sintering” or “debinding.” Sintering is done at a temperature or temperature profile and time sufficient to cause the particulate to form a solid object. Such object formation can occur by any temperature driven particulate bonding including atomic diffusion, some softening, minimal melting, etc. Intact particle to particle edge fusion occurs without substantial liquefaction of the metal particles. Significant softening or melting of the particle is to be avoided. No “debinding” step is needed in this technology when maximum packing and minimal polymer content is achieved. An initial heating step can often be required to remove volatiles other than that derived from the polymer at a temperature substantially less than the sinter temperature or less than about 200° C.

The term “x-y plane” generally refers to a horizontally positioned plane orthogonal to the force of gravity. The z-direction generally refers to the direction normal to or parallel to the force of gravity and substantially orthogonal to the x-y plane.

The term “close association” generally refers to the packing of particles or particulate distribution. In a polymer composite, within the polymer matrix, the particles can also closely associate. The interfacial modifier coating provides a homogeneous surface on the particle or particles even if the particles are dissimilar in composition or size. Said surface, because of its inert character, permits very high volume or weight fraction packing in green body with or without the polymer matrix. Before sintering, no particle to particle or a particle to polymer reaction is needed to provide the new composite material. Any new polymer composite material has the viscoelastic properties of the underlying polymer that is seen in the composite melt flow during extrusion or injection molding or in other viscoelastic properties such as, for example, tensile elongation.

The term “mechanically shaped” generally refers to any modification in shape of a preform object during filament deposition or after filament deposition is complete.

The term “nonoxidizing atmosphere” generally refers to an atmosphere devoid of oxygen and can comprise a substantial vacuum, nitrogen, hydrogen, a noble gas or mixtures thereof. The term “reducing atmosphere” also includes nonoxidizing characteristics but also includes the chemical nature that only the actions involving electron losses can occur. A reducing atmosphere comprises gases such as hydrogen, carbon monoxide, and other gaseous reactants. One aspect of a reducing atmosphere is that it can cause the removal of oxygen from a metal or metal oxide.

The term “or” is generally employed in its inclusive sense including “and/or” unless the content clearly dictates otherwise.

The terms “comprise or comprises” and variations thereof do not have a limiting meaning where these terms appear in the description and claims.

“Include,” “including,” or like terms means encompassing but not limited to, that is, including and not exclusive.

### BRIEF DESCRIPTION OF THE DRAWINGS

FIG. 1 shows an electron photomicrograph of a fracture zone of a sintered metal article. The test object was prepared by fracturing and not polishing the sintered article such that the surface of the test object is representative of the bonds between the adjacent particles that fracture during preparation. The figure shows the areas in the composite that generate x-ray fluorescence of zirconium atoms using the Lalpha1 transition emission or radiation.

FIG. 3 shows a similar fracture zone (see FIG. 1) of a test object. In the fracture zone can be seen the indentations caused by the removal of metal particulates at the interface between the particulate and adjacent material. Also shown in the figure are points 31 through 34, which are analyzed for the presence of specific atomic species. The spectra show the presence of zirconium atoms at residues derived from the bonds between adjacent particulates. FIG. 3 is a 100-micron photo micrograph as shown in the figure.

FIGS. 6 and 8 are photo micrographs like FIG. 3 showing similar fracture lines within a prepared test object made by fracturing a sintered article. Similarly, the points shown in the figure are representative of residues of the bonds between the individual metal particles that produce x-ray emission showing the presence of zirconium atoms in the bonding areas.

FIGS. 2, 4, 5, 7 and 9 are x-ray the spectra showing elements including bonding zirconium atoms and stainless steel atomic constituents detected in bonding portions of the test articles.

FIG. 10 is a view of the EDS emission or radiation from the distribution zirconium atoms on the fractured surface of a test object showing a visual representation of the distribution of zirconium atoms in the sintered article and in the bonding zones.

### DETAILED DISCUSSION

We have found that a metal particulate with a coating of an interfacial modifier (IM) can be formed as a green body and sintered into a final shaped article. The coated particulate can also be combined with a thermoplastic polymer and result in a particulate/polymer composite green body with green strength, high particle packing fractions and viscoelastic properties, such as melt flow, in a green body and sintered into a final shaped article.

The metal powder particles or particulate can consist of a single metal, an alloy of two or more metals or a dispersion of two or more metals. The metal can be a single crystal or many crystal grains of various sizes. The micro structure including a crystal grain size shape and orientation can also vary from metal to metal. The particle metallurgy depends on method of the particle fabrication. Metals that can be used in powder metal technology include copper metal, iron metal, nickel metal, tungsten metal, molybdenum, and metal alloys thereof and bi-metallic particles thereof. Often, such particles have an oxide layer that can interfere with shape formation. The metal particle composition used in particle metallurgy typically includes a large number of particulate size materials. The particles that are acceptable molding grade particulate include particle size, particle size distribution, particle morphology and aspect ratio. Further, the flow rate of the particle mass, the green strength of the initial shaped object, the object toughness, compressibility of the initial shaped object, the removability or ejectability of the shaped object from the mold, and the dimensional stability of the initial shape during processing and later sintering is also improved.

Metal particulate that can be used in the solid body molded composite materials include ferrous alloys, stainless steel, nickel alloys, chromium alloys, titanium alloys, cobalt alloys, aluminum, iron, copper, nickel, cobalt, tin, bismuth, zinc, tungsten, uranium, osmium, iridium, platinum, rhenium, gold, silver, neptunium, plutonium and tantalum. These metals may be used alone or as an alloy or in conjunction with other metals, inorganic minerals, ceramics, or glass bubbles and spheres.

The end use of the material to make the shaped article would be the determining factor. Another advantage is the ability to create bimetallic or higher materials that use two or more metal materials that cannot naturally form an alloy. These materials are not used as large metal particles, but are typically used as small metal particles, commonly called metal particulates. Such particulates have a relatively low aspect ratio and are typically less than about 1:3 aspect ratio. An aspect ratio is typically defined as the ratio of the greatest dimension of the particulate divided by the smallest dimension of the particulate. Using the interfacial modifier coating enables the part or shaped article to be made from particles of varied and amorphous morphology.

Metal particulate material, with a coating of an interfacial modifier (IM), and optionally a thermoplastic polymer, through a selection of particle type, particle size, particle shape, and interfacial modifier can form a composite to provide substantially improved green body products and processes. The IM has a dual fiction. The IM helps to form the green body. Once formed and after the IM has enabled green packing density, the IM can act to bond the sintered product.

In a final shaped article, the coating of interfacial modifier on the particulate results in substantially reduced shrinkage of the mass of particulate. Reduced shrinkage provides reproducibility of the part or shaped article. Further, the interfacial modifier coating permits very high packing fractions of the particles as the particles tend to self-order themselves to achieve the highest packing density in a volume of the particles. The resulting final shaped article products can exceed contemporary products at least in tensile strength, impact strength and density.

The metal particles generally useful in the claimed materials typically have a particle size of a minimum of 1, 2, 5, 10, or 20 microns, or a maximum of 180, 250, 300, 500 etc. microns that range from about 2 to 500, or 2 to 400, or 2 to 300, or 2 to 200, or 2 to 100 microns; or 1 to 200, or 1 to 300 microns; or 4 to 300, or 4 to 200, or 4 to 100 microns; and often 5 to 250, 5 to 150, 5 to 130, 5 to 125, or 5 to 100 microns. Composites can be made with a single particle size, two blended particles or three or more particles in a blend. In a single particle composite the packing can be about 75 to 85 or about 78 to 82%. Blended particles can attain higher packing levels. A combination of a larger and a smaller particle can obtain higher packing of 82 to 95%. wherein there is about 0.1 to 40 or 5 to 35 wt. % of the smaller particle and about 99.9 to about 60 or 95 to 65 wt. % of larger particles, and where the ratio of the diameter of the larger particles to the ratio of the smaller particles is about 2:1, 3:1, 4:1, 5:1, 6:1 or 7:1. In some embodiments there may be three or more components of particle sizes with size ratios such as about 50:7:1 or 350:50:7:1. In other embodiments there may be a continuous gradient of wide particle size distributions to provide higher packing densities or packing fractions. These percentages are based on the particulate. In some embodiments, there may be two or three or more components of particle sizes with specific size ratios. In two particulate blends, a first particulate that is greater than 100 microns is combined with a particulate that is less than 20 or less than 10 microns at a ratio of larger to smaller particulate of about 3-1 parts by weight of the larger to 1 part of the smaller. In three particulate blends, a first particulate that is greater than 100 microns is combined with a second particulate that is about 50 to 10 microns and a third particulate that is less than 10 microns at a ratio of first to second to third particulate of greater than about 10 parts by weight of the first to about 1 part of the second to less than about 5 of the third. These ratios will provide optimum self-ordering of particles within the polymer phase leading to tunable particle fractions within the composite material. The self-ordering of the particles is improved with the addition of interfacial modifier as a coating on the surface of the particle.

The major amount of particulate in the green body is a metal particulate. Optional minor amounts of component materials can be used as a particulate in combination with metal includes inorganic and ceramic materials. Ceramics are typically classified into three distinct material categories, including aluminum oxide and zirconium oxide ceramic, metal carbide, metal boride, metal nitride, metal silicide compounds, and ceramic material formed from clay or clay-type sources. Examples of useful technical ceramic materials are selected from barium titanate, boron nitride, lead zirconate or lead tantalite, silicate aluminum oxynitride, silica carbide, silica nitride, magnesium silicate, titanium carbide, zinc oxide, and/or zinc dioxide (zirconia). Particularly useful ceramics comprise the crystalline ceramics. Other embodiments include the silica aluminum ceramic materials that can be made into useful particulate. Such ceramics are substantially water insoluble and have a particle size that ranges from about 10 to 500 microns, have a density that ranges from about 1.5 to 3 gram/cc and are commercially available. In an embodiment, soda lime glass may be useful. One useful ceramic product is the 3M ceramic microsphere material such as the g-200, g-400, g-600, g-800 and g-850 products.

Examples of minerals that are useful in the embodiment include compounds such as Carbide, Nitride, Silicide and Phosphide; Sulphide, Selenide, Telluride, Arsenide and Bismuthide; Oxysulphide; Sulphosalt, such as Sulpharsenite, Sulphobismuthite, Sulphostannate, Sulphogermanate, Sulpharsenate, Sulphantimonate, Sulphovanadate and Sulphohalide; Oxide and Hydroxide; Halides, such as Fluoride, Chloride, Bromide and Iodide; Fluoroborate and Fluorosilicate; Borate; Carbonate; Nitrate; Silicate; Silicate of Aluminum; Silicate Containing Aluminum or other Metals; Silicates containing other Anions; Niobate and Tantalate; Phosphate; Arsenate such as arsenate with phosphate (without other anions); Vanadate (vanadate with arsenate or phosphate); Phosphates, Arsenates or Vanadate; Arsenite; Antimonate and Antimonite; Sulphate; Sulphate with Halide; Sulphite, Chromate, Molybdate and Tungstate; Selenite, Selenate, Tellurite, and Tellurate; Iodate; Thiocyanate; Oxalate, Citrate, Mellitate and Acetates include the arsenide, antimonide and bismuthide of e.g., metals such as Li, Na, Ca, Ba, Mg, Mn, Al, Ni, Zn, Ti, Fe, Cu, Ag and Au.

Garnet, is a nesosilicate mineral that complies with the general formula X₃Y₂(SiO₄)₃. The X is divalent cation, typically Ca²⁺, Mg²⁺, Fe²⁺ etc. and the Y is trivalent cation, typically Al³⁺, Fe³⁺, Cr³⁺, etc. in an octahedral/tetrahedral framework with [SiO₄]⁴⁻ occupying the tetrahedral structure. Garnets are most often found in the dodecahedral form, less often in trapezo-hedral form.

Particularly useful inorganic materials are metal oxide materials including aluminum oxide or zirconium oxide. Aluminum oxide can be in an amorphous or crystalline form. Aluminum oxide is typically formed from sodium hydroxide, and aluminum ore. Aluminum oxide has a density that is about 3.8 to 4 g-cc and can be obtained in a variety of particle sizes that fall generally in the range of about 10 to 1,000 microns. Zirconium oxide is also a useful ceramic or inorganic material. Zirconium dioxide is crystalline and contains other oxide phases such as magnesium oxide, calcium oxide or cerium oxide. Zirconium oxide has a density of about 5.8 to 6 gm-cm⁻³ and is available in a variety of particle sizes. Another useful inorganic material concludes zirconium silicate. Zirconium silicate (ZrSiO₄) is an inorganic material of low toxicity that can be used as refractory materials. Zirconium dioxide has a density that ranges from about 4 to 5 gm/cc and is also available in a variety of particulate forms and sizes. Optionally an inorganic particulate can be used. An inorganic material that can be used as a particulate in another embodiment includes silica, silicon dioxide (SiO₂). Silica is commonly found as sand or as quartz crystalline materials. Also, silica is the major component of the cell walls of diatoms commonly obtained as diatomaceous earth. Silica, in the form of fused silica or glass, has fused silica or silica line-glass as fumed silica, as diatomaceous earth or other forms of silica as a material density of about 2.7 gm-cm⁻³ but a particulate density that ranges from about 1.5 to 2 gm-cm⁻³.

Glass spheres (including both hollow and solid) are another illustrative non-metal or inorganic particulate useful in the claimed materials. These spheres are strong enough to avoid being crushed or broken during further processing, such as by high pressure spraying, kneading, extrusion or injection molding. In many cases these spheres have particle sizes close to the sizes of other particulate if mixed together as one material. Thus, they distribute evenly, homogeneously, within the composite upon introduction and mixing. The method of expanding solid glass particles into hollow glass spheres by heating is well known. See, e.g., U.S. Pat. No. 3,365,315 herein incorporated by reference in its entirety.

Useful hollow glass spheres having average densities of about 0.1 grams-cm⁻³ to approximately 0.7 grams-cm⁻³ or about 0.125 grams-cm⁻³ to approximately 0.6 grams-cm⁻³ are prepared by heating solid glass particles.

For a product of hollow glass spheres having a desired average density, there is an optimum sphere range of sizes of particles making up that product which produces the maximum average strength. A combination of a larger and a smaller glass sphere wherein there is about 0.1 to 25 wt. % of the smaller sphere and about 99.9 to about 75 wt. % of larger particles can be used were the ratio of the diameter of the larger particles to the ratio of the smaller is about 2:1, 3:1, 4:1, 5:1, 6:1 or 7:1. Percentages based on the particulate.

Glass spheres used within the embodiments can include both solid and hollow glass spheres. All the particles heated in the furnace do not expand, and most hollow glass-sphere products are sold without separating the hollow from the solid spheres.

Useful glass spheres are hollow spheres with relatively thin walls. Such spheres typically comprise a silica-lime or a silicate glass and in bulk form a white powdery particulate. The density of the hollow spherical materials tends to range from about 0.1 to 0.8 g/cc that is substantially water insoluble and has an average particle diameter that ranges from about 10 to 250 microns.

Magnetic inorganic or ceramic composites can be made of any magnetic particle material that when formed into a composite can be magnetized to obtain a permanent magnetic field. These particles are typically inorganic and can be ceramic. If raised to above a Curie temperature (T_{C}) with a loss of magnetic moment alignment, magnetism can be restored by conventional means. Magnetite is a mineral, one of the two common naturally occurring oxides of Iron (chemical formula Fe₃O₄) and a member of the spinel group. Magnetite is the most magnetic of all the naturally occurring minerals. Alnico magnet alloy is largely comprised of aluminum, iron, cobalt and nickel. Alnico is a moderately expensive magnet material because of the cobalt and nickel content. Alnico magnet alloy has a high maximum operating temperature and a very good corrosion resistance. Some grades of Alnico alloy can operate at high temperatures. Samarium cobalt (SmCo) and Neodymium Iron Boron (NdFeB) are called rare earth because neodymium and samarium are found in the rare earth elements on the periodic table. Both samarium, cobalt, and neodymium magnet alloys are powdered metals which are compacted in the presence of a strong magnetic field and are then sintered. Ceramic magnet material (Ferrite) is strontium ferrite. Ceramic magnet material (Ferrite) is one of the most cost effective magnetic materials manufactured in industry. The low cost is due to the cheap, abundant, and non-strategic raw materials used in manufacturing this alloy. The permanent ceramic magnets made with this material lend themselves to large production runs. Ceramic magnet material (Ferrite) has a fair to good resistance to corrosion and it can operate in moderate heat.

One useful magnetic particulate is a ferrite. Ferrite is a chemical compound consisting of a ceramic inorganic oxide material. Ferric oxide, commonly represented as Fe₂O3, is a principal component. Useful ferrite materials of the disclosure have at least some magnetic character and can be used as permanent magnet ferrite cores for transformers and as memory components in tape and disc and in other applications. Ferrite materials are ferromagnetic ceramic compounds generally derived from iron oxides. Iron oxide compounds are materials containing iron and oxygen atoms. Most iron oxides do not exactly conform to a specific molecular formula and can be represented as Fe2O3 or Fe₃O₄ as well as compounds as FeₓO_{y} wherein x is about 1 to 3 and y is about 1 to 4 including non-unitary substituents. The variation in these numbers result from the fundamental nature of the ferric oxide material which invoke often does not have precisely defined ratios of iron to oxygen atoms. These materials are spinel ferrites and are often in the form of a cubic crystalline structure. The crystalline usually synthetic ceramic material typically is manufactured by manufacturing a ferric oxide material and at least one other metallic oxide material generally made from a metal oxide wherein the metal is a divalent metal. Such metals include for example magnesium, calcium, barium, chrome manganese, nickel, copper, zinc, molybdenum and others. The useful metals are magnesium, calcium and barium.

Useful ferrites are typically prepared using ceramic techniques. Often the oxides are carbonates of iron or divalent oxides are milled until a fine particulate is obtained. The fine particulate is dried and pre-fired to obtain the homogenous product. The ferrite is then often heated to form the final spinel crystalline structure. The preparation of ferrites is detailed in U.S. Pat. Nos. 2,723,238 and 2,723,239. Ferrites are often used as magnetic cores in conductors and transformers. Microwave devices such as glycerin tubes can use magnetic materials. Ferrites can be used as information storage in the form of tape and disc and can be used in electromagnetic transistors and in simple magnet objects. One useful magnetic materials are known as zinc ferrite and has the formula ZnₓFe₃₋ₓO₄. Another useful ferrite is the barium ferrite that can be represented as BaO:6Fe₂ or BaFe₁₂O₁₉. Other ferrites include soft ferrites such as manganese-zinc ferrite (MnₐZn₍₁₋ₐ₎Fe₂O₄) and nickel zinc ferrite NiₐZn₍₁₋ₐ₎Fe₂O₄. Other useful ferrites are hard ferrites including strontium ferrite SrFe₂O₄, cobalt ferrite CoFe₂O₄.

We have found that by using an interfacially modified coated particulate that the molding processes can be improved. The coated particulate is more easily formed or shaped and the processes are more efficient in (e.g.) reduced process pressures. The coated particles when combined with polymer have improved melt flow properties when compared to conventional polymer composites. We have found that the green body and final products of the processes can be improved through the increased packing density of the particulate in the green and final products. The packing density, or packing fraction, is a useful predictor of the properties of the resulting products. The improved packing density typically has improved the strength, shielding properties, shape, definition, etc. of the final sintered product or shaped solid body article. Once formed the green body can be sintered to form a particle mass bonded with a unique bond structure in which the IM residue and the metal forms a bond structure.

We believe an interfacial modifier is a surface chemical treatment. In one embodiment, the interfacial modifier is an organo metallic material that provides an exterior coating on the particulate promoting the close association of particulate to other particulate without intra-particulate bonding or attachment. Amounts of the interfacial modifier can be used in minimal amounts of 0.005, 0.01, 0.05, 0.1, 0.2, 0.5, wt. % and in maximum amounts of about 5, 4, 3, 2 or 1 wt. % including about 0.005 to 8 wt. %, 0.005 to 4 wt. %, 0.010 to 3 wt. %, 0.02 to 3 wt. % or about, 0.02 to 2 wt. %. The weight percent of interfacial modifier is based on the composite. The interfacial modifier coats but does not form any substantial covalent bonding among or to other particulate or polymer.

Organometallic interfacial modifiers provide the close association of the particulate within a particle distribution of one or many sizes. Interfacial modifiers used in the application fall into broad categories including, for example, titanate compounds, zirconate compounds, hafnium compounds, samarium compounds, strontium compounds, neodymium compounds, yttrium compounds, metal phosphonate compounds, aluminate and metal aluminate compounds. Useful, aluminate, phosphonate, titanate and zirconate compounds contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen and sulfur. Commonly the titanate and zirconate compounds contain from about 2 to about 3 ligands comprising hydrocarbyl phosphate esters and/or hydrocarbyl sulfonate esters, commonly 3 of such ligands and about 1 to 2 hydrocarbyl ligands, commonly 1 hydrocarbyl ligand.

In one embodiment, the interfacial modifier used is a type of organo-metallic material such as organo-titanate, organo-boron, organo-aluminate, organo-strontium, organo-neodymium, organo-yttrium, or organo-zirconate compounds. The specific type of organo-titanate, organo-aluminate, organo-hafnium, organo-strontium, organo-neodymium, organo-yttrium, or organo-zirconate compounds may be referred to as organo-metallic compounds and are distinguished by the presence of at least one hydrolysable group and at least one organic moiety. Mixtures of the organo-metallic materials may be used. The mixture of the interfacial modifiers may be applied inter- or intra-particle, which means at least one particle may have more than one interfacial modifier coating the surface (intra), or more than one interfacial modifier coating may be applied to different particles or particle size distributions (inter). These types of compounds may be defined by the following general formula:

M(R₁)ₙ(R₂)ₘ

wherein M is a central atom selected from, for example, Ti, Al, Hf, Sa, Sr, Nd, Yt, and Zr; R₁ is a hydrolysable group; R₂ is a group consisting of an organic moiety; wherein the sum of m+n must equal the coordination number of the central atom and where n is an integer ≥1 and m is an integer ≥1.

Particularly R₁ is an alkoxy group having less than 12 carbon atoms. Useful are those alkoxy groups, which have less than 6, and most Useful are alkoxy groups having 1-3 C atoms. R₂ is an organic group including between 6-30, commonly 10-24 carbon atoms optionally including one or more hetero atoms selected from the group consisting of N, O, S and P. R₂ is a group consisting of an organic moiety, which is not easily hydrolyzed, often is lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic.

Useful titanate and zirconate compounds include isopropyl tri(dioctyl)pyrophosphato titanate (available from Kenrich Chemicals under the designation KR38S), neopentyl(diallyl)oxy, tri(dodecyl)benzene-sulfonyl titanate (available from Kenrich Chemicals under the trademark and designation LICA 09), neopentyl(diallyl)oxy, trioctylphosphato titanate (available from Kenrich Chemicals under the trademark and designation LICA 12), neopentyl(diallyl)oxy, tri(dodecyl)benzene-sulfonyl zirconate (available from Kenrich Chemicals under the designation NZ 09), neopentyl(diallyl)oxy, tri(dioctyl)phosphato zirconate (available from Kenrich Chemicals under the designation NZ 12), and neopentyl(diallyl)oxy, tri(dioctyl)pyro-phosphato zirconate (available from Kenrich Chemicals under the designation NZ 38). One embodiment is titanate is tri(dodecyl)benzene-sulfonyl titanate (available from Kenrich Chemicals under the designation LICA 09).

The interfacial modifiers modify the particulate in the materials with the formation of a layer on the surface of the particle reducing the intermolecular forces, improving the tendency of particle to mix with other particles, and resulting in increased material density. Interfacial modifier coatings on particulate, in contrast with uncoated particulate, maintain or improve the viscoelastic properties of the base polymer in the composite material. For example, such viscoelastic properties may be melt flow, elasticity, tensile modulus, storage modulus, elastic-plastic deformation and tensile elongation can be present in the composite material. Interfacial modifiers coatings on particulate also improve the rheology of the composite material causing less wear on machinery and other technology useful in melt processing. Further, the interfacial modifier coatings on particulate provide an inert surface on the particulate substrate. The coated particulate is unreactive to the base polymer or other additives in the composite material. In a sense, the interfacial modifier coatings on particulate make the particulate invisible or immiscible to the base polymer or other additives in contrast to particulate that is uncoated. Density is maximized as the number of close associations between the particulate surfaces. After sintering the IM leaves non-volatile reside on the surface that typically is the metallic portion of the IM. This residue can cooperate to form a bond with the particle surface.

The choice of interfacial modifiers is dictated by particulate, polymer, and application. The particle is completely coated with the interfacial modifier even with substantial surface morphology. By substantial surface morphology, visual inspection would show a rough surface to a particle substrate where the surface area of the rough substrate, considering the topography of the surface, is substantially greater than the surface area of a smooth substrate. Interfacial modifying coatings or surface treatments may be applied to any particle type such as ceramic, inorganic, metal particulate or their mixtures. The maximum density of a material in the composite material with the polymer is a function of the densities of the materials and the volume fractions of each. Higher density materials are achieved by maximizing per unit volume of the materials with the highest densities and can be measured by application of Equation 1.

A large variety of polymer materials can be used with the interfacially modified particulate of the embodiment. For this application, a polymer is a general term covering either a thermoplastic polymer or blends or alloys thereof. We have found that polymer materials that are useful include both condensation polymeric materials and addition or vinyl polymeric materials. Crystalline or semi-crystalline polymers, copolymers, blends and mixtures are useful. Included are both vinyl and condensation polymers, and polymeric alloys thereof. Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation. Vinyl polymers include polyethylene, polypropylene, polybutylene, polyvinyl alcohol(PVA), acrylonitrile-butadiene-styrene (ABS), poly(methyl-pentene), (TPX®), polybutylene copolymers, polyacetyl resins, polyacrylic resins, homopolymers or copolymers comprising vinyl chloride, vinylidene chloride, fluorocarbon polymers and copolymers, etc. Vinyl polymer polymers include acrylonitrile; polymer of alpha-olefins such as ethylene, high density polyethylene (HDPE), propylene, etc.; chlorinated monomers such as vinyl chloride, vinylidene dichloride, acrylate monomers such as acrylic acid, methylacrylate, methyl methacrylate, acrylamide, hydroxyethyl acrylate, and others; styrenic monomers such as styrene, alpha methyl styrene, vinyl toluene, etc.; vinyl acetate; and other commonly available ethylenically unsaturated monomer compositions. Also useful are fluoropolymers such as vinylidene fluoride polymers primarily made up of monomers of vinylidene fluoride, including both homo polymers and copolymers. Such copolymers include those containing at least 50 mole percent of vinylidene fluoride copolymerized with at least one comonomer selected from the group consisting of tetrafluoroethylene, trifluoroethylene, chlorotrifluoroethylene, hexafluoropropene, vinyl fluoride, pentafluoropropene, and any other monomer that readily copolymerizes with vinylidene fluoride. The vinyl polymer has a density of at least 0.85 gm-cm⁻³, however, polymers having a density of greater than 0.96 are useful to enhance overall product density. A density is often up to 1.7 or up to 2 gm-cm⁻³ or can be about 1.5 to 1.95 gm-cm⁻³ depending on metal particulate and end use.

Another class of vinyl thermoplastic includes styrenic copolymers. The term styrenic copolymer indicates that styrene is copolymerized with a second vinyl monomer resulting in a vinyl polymer. Such materials contain at least a 5 mol-% styrene and the balance being 1 or more other vinyl monomers. A class of these materials is styrene acrylonitrile (SAN) polymers. SAN polymers are random amorphous linear copolymers produced by copolymerizing styrene acrylonitrile and optionally other monomers. Emulsion, suspension and continuous mass polymerization techniques have been used. SAN copolymers possess transparency, excellent thermal properties, good chemical resistance and hardness. These polymers are also characterized by their rigidity, dimensional stability and load bearing capability. Olefin modified SAN's (OSA polymer materials) and acrylic styrene acrylonitriles (ASA polymer materials) are known. These materials are somewhat softer than unmodified SAN's and are ductile, opaque, two phased terpolymers that have surprisingly improved weatherability.

Another class of vinyl thermoplastic are ASA that are random amorphous terpolymers produced either by mass copolymerization or by graft copolymerization. These materials can also be blended or alloyed with a variety of other polymers including polyvinyl chloride, polycarbonate, polymethyl methacrylate and others. A class of styrene copolymers includes the acrylonitrile-butadiene-styrene monomers (ABS). These polymers are very versatile family of engineering thermoplastics produced by copolymerizing the three monomers. The styrene copolymer family of polymers has a melt index that ranges from about 0.5 to 25, commonly about 0.5 to 20.

Classes of engineering polymers that are useful include acrylic polymers. Acrylics comprise a broad array of polymers and copolymers in which the major monomeric constituents are an ester acrylate or methacrylate. These polymers are often provided in the form of hard, clear sheet or pellets. A Useful acrylic polymer material that is useful in an embodiment has a melt index of about 0.5 to 50, commonly about 1 to 30 gm/10 min.

Condensation polymers that are useful include polyamides, polyamide-imide polymers, polyarylsulfones, polycarbonate, polybutylene terephthalate, polybutylene naphthalate, polyetherimides (such as, for example, ULTEM®), polyether sulfones, polyethylene terephthalate, thermoplastic polyimides, polyphenylene ether blends, polyphenylene sulfide, polysulfones, thermoplastic polyurethanes and others. Useful condensation engineering polymers include polycarbonate materials, polyphenyleneoxide materials, and polyester materials including polyethylene terephthalate, polybutylene terephthalate, polyethylene naphthalate and polybutylene naphthalate materials. Useful polycarbonate materials should have a melt index between 0.5 and 7 gms/10 min, commonly between 1 and 5 gms/10 min.

Condensation polymers include nylon, phenoxy resins, polyarylether such as polyphenylether, polyphenylsulfide materials: polycarbonate materials, chlorinated polyether resins, polyethersulfone resins, polyphenylene oxide resins, polysulfone resins, polyimide resins, thermoplastic urethane elastomers and many other resin materials. A variety of polyester condensation polymer materials including polyethylene terephthalate, polybutylene terephthalate, polyethylene naphthalate, polylactic acid, polybutylene naphthalate, etc. can be useful in the composites. Such materials have a useful molecular weight characterized by melt flow properties. Useful polyester materials have a viscosity at 265° C. of about 500-2000 cP, commonly about 800-1300 cP. Polyphenylene oxide materials are engineering thermoplastics that are useful at temperature ranges as high as 330° C. Polyphenylene oxide has excellent mechanical properties, dimensional stability, and dielectric characteristics. A useful melt index (ASTM 1238) for the polyphenylene oxide material useful typically ranges from about 1 to 20, commonly about 5 to 10 gm/10 min. The melt viscosity is about 1000 cP at 265° C. Other thermoplastics may be useful depending on the final manufacturing processes of extrusion and sintering.

Polymer blends or polymer alloys can be useful in manufacturing the pellet or linear extrudate of the embodiments. Such alloys typically comprise two miscible polymers or a solution of polymers blended to form a uniform composition. Scientific and commercial progress in polymer blends has led to the realization that physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (Tg). Immiscible or non-alloyed blend of polymers typically displays two or more glass transition temperatures associated with immiscible polymer phases. In the simplest cases, the properties of polymer alloys reflect a composition weighted average of properties possessed by the components. In general, however, the property dependence on composition varies in a complex way with a property, the nature of the components (glassy, rubbery or semi-crystalline), the thermodynamic state of the blend, and its mechanical state whether molecules and phases are oriented.

The primary requirement for the substantially thermoplastic polymer material is that it retains sufficient thermoplastic properties, such as viscosity and stability, to permit melt processing, such as melt blending, with a particulate, permit formation of linear extrudate pellets, and to permit the composition material or pellet to be extruded or injection molded in a thermoplastic process forming a green product, and to permit formation of a brown and final product. Polymer and polymer alloys are available from a few manufacturers including Dyneon LLC, B.F. Goodrich, G.E., Dow, PolyOne, Mitsui, and DuPont.

The choice of the polymer for the composite to make the green body may depend on a wide number of independent and interdependent variables. Understanding of these variables and their interactions may require some preliminary testing such as, for example, melt flow rates, viscosity, and density of the composite material so that the ultimate product meets the performance specifications for the part or object. For example, melting point and softening point of the polymer may be relevant to both composite formulation as well as manufacture of the shaped article. Additional polymer aspects may include amorphous, crystalline or semi-crystalline character of the base polymer, copolymer or blends.

The waxes useful herein may include paraffin waxes, microcrystalline waxes, high-density low molecular weight polyethylene waxes, by-product polyethylene waxes, Fischer-Tropsch waxes, oxidized Fischer-Tropsch waxes and functionalized waxes such as hydroxyl stearamide waxes and fatty amide waxes. It is common in the art to use the terminology synthetic high melting point waxes to include high-density low molecular weight polyethylene waxes, by-product polyethylene waxes and Fischer-Tropsch waxes.

In accordance with disclosed concepts, the packing density or particle fraction of particles in the green body material (molded or additive processed) is improved. The density varies to specifications required for the utility of the final shaped product as molded and sintered. Values for packing density in a 3D or an additive manufactured product, the volume percent, may be greater than 60, 65, 70, 75, 80, 85, 90, 97%, with amounts of polymer less than 10, 5, 4, or 3 vol. %. Packing can also be seen in the amount of excluded volume. Excluded volume (outside particulate) that can be occupied by polymer can range from 10 to 80 vol. %, 10 to 70 vol. %, 13 to 61 vol. % 3 to 22 vol. % or 5 to 18 vol. %. Packing percentage based on the composite and can also be seen in the amount of excluded volume.

The packing density, or particle fraction of particles, in the brown body material varies to specifications required for the utility of the final shaped product as molded and sintered. Values for packing density, volume percent, may be greater than 50, 55, 65, 70 75, 80, 85, 90, 95, or 99 vol. %, with amounts of polymer less than 20, 15, 10, 5, 4, or 3 vol. %. Packing can also be seen in the amount of excluded volume. Volume percentages are based on the composite.

Similarly, in the molded green body, which contains polymer before sintering, the molded green body can contain greater than 75 to 82 vol. % volume packing. Similarly, in the green body obtained by additive process or 3D methods, which contains polymer before sintering, the green body can contain greater than 60 vol. % volume packing.

Excluded volume is the volume not occupied by the IM coated particulate. In large part, this excluded volume is substantially or fully filled with polymer. Such a combination of packing and polymer content provides minimal shrinkage less than 10, 9, 8, 7, 6, 5, 4, 3, 2 or 1 vol. %, and permits part manufacture to avoid a debinding step. The maximum loading ratio of treated particles to polymer was calculated based upon the actual or pyncnometer density and powder puck density, shown in Equation 1. Procedures to measure the loading ratio of treated, or coated, particles in polymer is calculated based upon the density of the material density and powder press density, as shown in Equation 1.

Packing (Loading) (%)=packed powder density/material density (Eq. 1)

In the case of metals, the materials may be refractory metals such as niobium, molybdenum, tantalum, tungsten and rhenium and in some instances titanium, vanadium, chromium, zirconium, hafnium, ruthenium, osmium and iridium, useful metals are ferrous metals and alloys thereof, such as stainless steel. These materials are extremely hard, have a high melting point, usually above 1500° C., and are difficult to deform. These materials may be formed into usable shapes using traditional powder metallurgy equipment. However, the maximum densities achievable with conventional materials will be less then optimum and there may be excessive shrinkage of the particulate mass upon sintering. When forming shaped articles, or linear extrudate, the inter-particle interaction dominates the behavior of the total material. Particles contact one another and the combination of irregular shape, interacting sharp edges, soft surfaces (resulting in gouging, points are usually work hardened) and the friction between the surfaces prevent further or optimal packing. Therefore, maximizing properties, such as increasing the melt flow properties, reducing viscosity, the particulate mass of a material, is a function of softness of surface, hardness of edges, point size of point (sharpness), surface friction force and pressure on the material, circularity, and the usual, shape size distribution of the particles. In general, these effects are defined as particle surface energy interactions. Such interactions can be inhibitory to forming materials with requisite properties such as high density or low porosity. Further because of this inter-particle friction, the forming pressure will decrease exponentially with distance from the applied force. The circularity of the particle is calculated by the following Equation 2:

Circularity=(perimeter)²/area. (Eq. 2)

An ideal spherical particle has a roundness characteristic of about 12.6. This characteristic is a unitless parameter of less than about 100, often about greater than 15 and can be between 20 to 50. Non-spherical particles can have improved physical properties arising from the interactions between the more irregular shapes,

Interfacially modifying chemistries can modify the surface of the homogeneous or heterogenous particulate populations. The interfacial modifier will coat the surface of the particle. After treatment with the interfacial modifier, the surface of the particle behaves as a particle of the non-reacted end of the interfacial modifier. The interfacial modifier coating of the surface of the particle modifies the surface energy of the bulk particulate relative to the surface characteristics of the interfacial modifier.

During powder metallurgical operations, such as sintering, each modified particle surface is bonded to at least one other modified particle surface at a particle to particle bond comprising a particle edge fusion interaction comprising a combination of the metal atoms from each particle and the metal of the organo metallic interfacial modifier. In ferrous metal bonding, the particle to particle bond contains iron combined with alloy metals and interfacial modifier metals. Such bonds contain Fe, and one or more metal selected from Cr, Mn, Mo, Co, Zr, Ti, etc. With interfacial modifiers, the topography of particle surfaces, surface morphology, such as for example, roughness, irregular shape etc., is modified to reduce these inter-particle surface effects. The particulate distribution with individual particles having an interfacially modified surface, although perhaps comprising different particle sizes, has a more homogeneous surface in comparison to non-interfacially modified particulate. The interfacial modifier reduces, such as for example, surface energies on the particle surface permitting a denser packing of particle distributions. In one embodiment the reduction of particle surface energy due to interfacial modification of particle surfaces provides self-ordering of different particle sizes to proceed and results in high volume particle packing. In contrast, particles with no interfacial modification will resist self-ordering.

These coated particles are not only non-reactive to each other and to the polymer or resin but also reduce the friction between particles thereby preventing gouging and allowing for greater freedom of movement among and between particles in comparison to particles that do not have a coating of interfacial modifier or have a coupling agent on their surface. The polymer composites also have improved melt flow properties. These phenomena allow the applied shaping force to reach deeper into the form resulting in a more uniform material and uniform pressure gradient during processing.

In an embodiment, the polymer is combined with a major proportion of metal particulate and a lesser amount of a non-metal particulate each coated with interfacial modifier. The coated particulate may be ceramic, mineral, glass bubbles, glass spheres or combinations and mixtures. The particulate, interfacial modifier, and polymer stock has been described supra. Composite material is made by adding particulate that has been pre-coated or pre-treated with interfacial modifier to a polymer. Interfacial modifier is not added separately to the polymer during processing. Depending on the requirements and specifications for making a shaped article the composition can be 0.005% to 1, 2, 3, 4, 5, 6, 7, 8, 9 or 10 wt. % interfacial modifier, 35% to 40, 55, 60, 65, 70, 75, 80, 85, 90, or 95 vol. % of particulates, and a minimum amount of polymer of about 1, 2, 3, 4, 5 10, 15, 18 or 25 vol. % including a maximum amount of about 25 vol. % 20 vol. % 18 vol. % 15 vol. % or 10 vol. % such as a range of about 1 to 25 vol. %, 2 to 18 vol. %, 5 to 15 vol. %, 5 to 10 vol. %. The volume percentage based on the composite, all depending on particulate, polymer and blending ratios. These components are mixed together to make a composite material and then molded.

The attributes of the composition of the composite material are many. High volume packing, greater than 60%, 65%, 70%, 75%, 80%, 82%, 85%, or 90 vol. %, can be realized with the compositions of the composite material. With said high volume fractions, the mechanical properties of the composite material used in the sintered object are improved, such as greater impact resistance, increased densification, resistance to oxidation, minimal shrinkage and improved sintering characteristics for MIM, Press and Sinter, and other powder metallurgical processes in comparison to materials that contain particulate this is not coated with an interfacial modifier. Highly packed particulate has excluded volume primarily filled by polymer. The excluded volume can be less than 40%, 35%, 30%, 25%, 20%, 18%, 15%, or 10 vol. %.

In a product embodiment, a selected particulate having specified particle metallurgy can be combined with a specific amount of an interfacial modifier to form a coating of the modifier on a particle. The coated particulate can optionally be combined with a thermoplastic polymer to form a composite. A green body can be formed from the composite by molding such as injection molding or compression molding prior to sintering. In a product embodiment, a selected particulate having specified particle metallurgy can be combined with a specific amount of an interfacial modifier to form a coating of the modifier on a particle and optionally combined with a thermoplastic polymer to form a green body by additive or 3D process prior to sintering. When sintered, the resulting brown body and final shaped article has minimal shrinkage, and enhanced physical/mechanical properties.

In a process embodiment, a selected particulate having specified particle metallurgy can be combined with a specific amount of an interfacial modifier to form a coating of the modifier on a particle and combined with a thermoplastic polymer to form a green body by with desirable rheology prior to sintering. Such rheology promotes efficient and reproducible manufacture of the green and brown bodies.

In another embodiment, an extrusion process can be used with the interfacially modified particulate to obtain improved processing properties. Using the interfacial modifier, the extrusion produced products and injection molding products, including the green product, filaments, and the final sintered product, can be obtained with minimum excluded volume and maximum particulate packing densities.

In one embodiment, the initial shapes, such as feedstock, or structures are made by consolidating the coated metal particulate polymer composite by heat and/or pressure via extrusion or injection molding. Then, the polymer is removed by thermal, chemical or other means. In a final step, the metal or particulate mass of the composite becomes very like the characteristics of the pure particulate in a process known as sintering. After sintering the metal or particulate mass is substantially free of polymer. At a minimum, the composite consolidation produces a coherent mass of a definitive size and shape for further processing or development. The characteristics of the initial pressed shape or object are influenced by the characteristics of the powder, the grade and manner of pressure application, the maximum pressure applied, the creative time of consolidation, the shape of the die, compaction temperature, and optional additives such as lubricants, alloy agents, dies materials, service conditions and other effects. The composite material comprising polymer and interfacially modified particulate at a high packing fraction has at least some of the characteristics of the underlying polymer viscoelastic properties, such as melt flow, elastic plastic deformation, etc., that allows the green body or feedstock to be formed without excessive pressures or equipment wear. After sintering, the object or shape can be worked, heated, polished, painted or otherwise finished into new shapes or structures.

Metal particulates can be formed into specific structural parts using conventional technology. Typical useful materials include iron, iron alloys, steel, steel alloys, brass, bronze, nickel and nickel-based alloys, copper, aluminum, aluminum alloys, titanium, titanium alloys, etc. The metallic particulate can be used to make porous materials such as high temperature filters, metering devices or orifices, manifolds, reservoirs, brake parts, iron powder cores, refractory materials, metal matrix composites, and others.

In the manufacture of useful products with the composites of the embodiment, the manufactured composite can be obtained in appropriate amounts, subjected to heat and pressure, typically using powder metallurgy processes and equipment, such as sintering, and then formed into an appropriate shape having the correct amount of materials in the appropriate physical configuration.

The manufacture of the particulate and polymer composite materials depends on good manufacturing technique. Such techniques are fully described in U.S. Pat. No. 7,491,356 “Extrusion Method Forming an Enhanced Property Metal Polymer Composite” and U.S. patent application publications U.S. 2010/0280164 “Inorganic Composite”, U.S. 20100280145 “Ceramic Composite”, and U.S. 2010/0279100 “Reduced Density Glass Bubble Polymer Composite” herein incorporated in their entirety. Often the particulate is initially treated with an interfacial modifier by spraying the particulate with a 25 wt.-% solution of the interfacial modifier on the particle with blending and drying carefully to ensure uniform particulate coating of the interfacial modifiers. Interfacial modifiers may also be added to particles in bulk blending operations using high intensity Littleford or Henschel blenders. Alternatively, twin cone mixers can be followed by drying or direct addition to a screw-compounding device. Interfacial modifiers may also be combined with the metal particulate in aprotic solvent such as toluene, tetrahydrofuran, mineral spirits or other such known solvents.

The composite materials having the desired physical properties can be manufactured as follows. In a useful mode, the surface coating of the particulate with the interfacial modifier is initially prepared. The interfacial modifier is coated on the prepared particle material, and the resulting product is isolated, dried, and then combined with the continuous polymer phase. In the composite, the coating of the interfacial modifier on the particle is less than 1 micron thick, in some cases atomic (0.5-10 Angstroms) or molecular dimensions (1-500 Angstroms) thick. In one aspect, the function of the interfacial modifier isolates the polymer from the particle as well as from the other particles. The polymer “sees” only the coating material and does not react to the interfacial modifier coating in any substantial way.

The physical properties of the green part are substantially improved by the high volume packing due to the self-ordered particulate. Such improved physical properties in the green part results in a product that can be shaped, processed, and handled with minimal concern for product damage before sintering. The physical properties of the brown body are substantially improved by the nature of the particle to particle bonding, by packing and the self-ordered particulate.

Similarly, the green part is resistant to dimensional change after molding but before sintering. In parts without substantial packing and self-ordering, after part formation but before sintering, portions of complex parts, having reduced dimensions, can be distorted by gravity forces. Such parts require a molded support when molded but before sintering. After sintering the support must be removed mechanically, a step that can cause product damage to sensitive parts. The green parts claimed can be made with no such supports in both simple and complex parts. As a result, the claimed technology results in reduced waste and reduced post sintering processing. Such dimensional change can be directly observed in a green part. Resistance to dimensional change can be measured by testing for compressive strength.

The manufacture of specific articles or shapes solid body molding from the particulate is dominated by the physical properties of the particulate, such as, for example, size, shape, and morphology, polymer such as, for example, melt flow, and interfacial modifier. The methods of manufacturing the metal particulate are discussed below in conjunction with the discussion of the particulates themselves. But it is understood that these methods of manufacturing, with suitable modifications directed to the components and end use of the product, are appropriate for other types of particulate such as inorganic mineral particulate, glass bubbles and glass spheres, and ceramic particulate testing via ASTMD638-10 Standard Test Method for Tensile Properties of Plastics and ASTM D1238-10 Standard Test Method for Melt Flow Rates of Thermoplastics by Extrusion Plastometer may be performed to characterize the composite material. Depending on the nature of the final composite material, suitable and necessary modifications to the test method may be made to produce accurate and industrial significant results. Viscosity measurements for composite materials are greater than 30, greater than 40, greater than 50, greater than 60, or greater than 60 PaS.

Once the composite material is prepared, it is then formed into the green body desired shape of the end use material for MIM or feedstock for 3D printing. Solution processing is an alternative that provides solvent recovery during materials processing. The materials can also be dry-blended without solvent. Blending systems such as ribbon blenders obtained from Drais Systems, high density drive blenders available from Littleford Brothers and Henschel are possible. Further melt blending using Banberry, single screw or twin-screw compounders is also useful. When the materials are processed as a plastisol or organosol with solvent, liquid ingredients are generally charged to a processing unit first, followed by polymer, particulate and rapid agitation. Once all materials are added a vacuum can be applied to remove residual air and solvent, and mixing is continued until the product is uniform and high in density.

Dry blending is generally useful due to advantages in cost. However certain embodiments can be compositionally unstable due to differences in particle size. In dry blending processes, the composite can be made by first introducing the polymer, combining the polymer stabilizers, if necessary, at a temperature from about ambient to about 60° C. with the polymer, blending an interfacially modifier coated particulate with the stabilized polymer, blending other process aids, colorants, indicators or lubricants followed by mixing in hot mix, transfer to storage, packaging or end use manufacture.

The composite formulation for shaped article of a green body or feedstock, whether formed with interfacially modified metal, inorganic, or glass bubble particulate, has attributes of a high-volume particle fraction packing, and improved mechanical/physical properties such as viscoelasticity and melt flow. After sintering the shaped article can have increased densification, resistance to oxidation, and minimal shrinkage. The post-sintered shaped article, substantially free of polymer, has the physical and mechanical characteristics of the underlying particulate. Further, the sintering process is much improved due to the characteristics and properties of the viscoelastic composite.

For powder injection molding, metal injection molding or additive manufacturing with the disclosed composite material, the particulate material such as ceramic, inorganic, glass, metal particulate are non-ductile resources, but they can be used in shaping processes, if they are mixed with materials such as organic substances. These organic substances are, such as for example polymers, also called “binder.”

The use of polymer as a binder varies according to the processing method and the particulate mixture. Binders give the green body a sufficient strength by associating particles at their boundary surfaces. Usually those binders are used as plasticizers. They make possible the flow of the particulate during processes such as extruding, injection molding, and additive manufacturing. The interfacially modified particulate can attain volume or weight packing levels in the composite material that are greater than theoretical, but the composite material does retain its melt flow and rheological characteristics that are useful in extrusion, metal injection molding and additive manufacturing.

In brief, the process for powder injection molding, metal injection molding or additive manufacturing with the disclosed composite material may take many variations, but the key steps are 1) feedstock preparation of the composite material used for the body of a part or object, 2) injection molding or laying down of layers of composite material using additive manufacturing techniques to form a “green body” of the part or object and 3) sintering the part or object. Preparation of the feedstock or the composite material of the embodiment to provide a homogeneous, highly packed coated particulate, injection molding and additive manufacturing processes have been disclosed. In molding processes a molding body with a maximum dimension of about 0.05 to 5 mm can be used. In additive manufacture a filament can be used with a diameter of about 0.1 to 5 mm.

Before sintering green bodies, the debinding process of the polymers to form the brown body, such as, for example, the removal of the polymer material, is not always needed but can be performed. The removal of the binder is via degradation, extraction or evaporation via the surface channels in the “green body” can be accomplished in the sintering step. Debinding is not desired and can be the most time consuming and expensive step in the part or object formation. Debinding the part may be done via thermal, solvent or catalytic methods. Binder material is chosen based on the selection of the debinding method. The higher volume or weight fractions of the coated particulate permits the use of less binder in the part or object, and the rheology and melt flow of the composite material provide for the part or object to be more quickly formed. Such higher particulate fractions are not possible with uncoated particulate.

The temperatures for thermal debinding vary but are often between 60° C. and 600° C. Organic polymers and organic components of the interfacial modifiers must be removed substantially completely from the green body, since carbon delays or can influence the sinter process. Further the qualities of the final product can be negatively impacted by residual carbon from the polymer. The debinding process typically is a time intensive step in the complete production process. The speed of decomposition of the polymers should not exceed the transport velocity of the products of pyrolysis, since an excess pressure of the gaseous pyrolysis products can lead to fractures and to the destruction of the brown body. Debinding can cause part irregularity and reduced density.

Binders can be classified into three classes 1) slip additives, 2) binding agents and 3) plasticizers or plasticizers. Slip additives are used to reduce the internal friction of particulates during pressing and to allow a non-destructive and fast release of the mold from the die. Slip additives are added as aqueous solutions in corresponding concentrations or as powder, which will be mixed with the mass. Binding agents are added to increase the flexural strength of the pressed body and plasticizers may increase the plasticity of the mass especially when the forming will be done in piston presses or in screw extrusion presses. The amount of plasticizer varies between 0.2 wt. % and 1 wt. % and depends on the grain size of the mass, on the dimension of the mold and the pressure of the press.

Organic plasticizers systems must be distinguished between 1) aqueous systems, 2) solvent containing systems, and 3) thermoplastic systems. Aqueous plasticizers systems consist of dispersions or solvents of polymers where the water has the function of deflocculant or solvent. The effectivity of plasticizers is not only caused by the structure of polymers but also supported by the water content. Solvent containing systems are disappearing in particulate production facilities because of the increasing demands of environment protection, workplace hygiene and safe working conditions. Thermoplastic systems were originally developed for injection molding machines in the plastics industry. Thermoplastic systems are exemplified, for example, by paraffin, wax, polyolefin wax materials; thermoplastic resins such as polyolefin, polypropylene (PP), polyethylene (PE), polyacetal, polyoxymethylene (POM). Molecular chains of polyolefin thermoplastic, polypropylene (PP) and polyethylene (PE) resins are much longer than those of waxes. This difference arises in higher binding forces of thermoplastics and therefore a higher melting viscosity and melting point.

In the appropriate product design, during composite manufacture or during product manufacture, a pigment or other dye material can be added to the processing equipment. One advantage of this material is that a dye or pigment can be co-processed resulting in a material that needs no exterior painting or coating to obtain an attractive, functional, or decorative appearance. The pigments can be uniformly distributed throughout the material and can result in a surface that cannot chip, scar or lose its decorative appearance. One particularly pigment material comprises titanium dioxide (TiO₂). This material is extremely non-toxic, is a bright white particulate that can be easily combined with either metal, glass, non-metal, inorganic or mineral particulates to enhance the novel characteristics of the composite material and to provide a white hue to the ultimate composite material.

The thermal treatment of the debinding process destroys the polymers by oxidation or combustion in an oxygen containing atmosphere. Very often it is an uncontrolled reaction of high reaction rate inside the shaped part creating a high gas pressure, which can lead to ruptures within the part. It is useful to transfer reactive thermoplastics into a modification of radical decomposition, which is easier to oxidize. This is a way to transfer polymers of high viscosity into substances of oily consistency. The radical decomposition will start with a defined temperature and continue as a chain reaction. Also, in hydrogen atmospheres a de-waxing process can be accomplished, but of course, instead of an oxidation a hydrogenation of decomposition products will occur.

The defining physical procedures of thermal debinding are 1) the capillary flow, 2) the low-pressure diffusion process, and 3) the high-pressure permeation process. The capillary forces involve liquid extraction, while the other two require the binder to be a vapor. Slightly elevated temperatures influence the viscosity and surface tension of the organic liquid; capillary forces start with the transport of the liquid phase from big to small pores. As soon as binder arrives at the surface it will be vaporized, if its vapor pressure is larger than the ambient pressure. With increasing temperature, the kinetics of volatilization increases too. Above a certain temperature the capillary forces cannot saturate the demand of volatilization of the liquid at the surface and the interface of both the vapor and the liquid is pulled back to the inside of the body.

The binder may be thermally decomposed into low molecular weight species, such as H₂O, CH₄, CO₂, CO etc. and subsequently removed by diffusion and permeation. The difference between diffusion and permeation depends on the mean free path of the gas species. The mean free path varies with the pressure, molecular weight of the gas and pore dimensions. Generally, diffusion will be dominant at low pressures and small pore sizes; permeation would be expected to control debinding with large pore sizes and high vapor pressures, where laminar flow controls the rate of gas exit from the compact. Typically, the pressure of a debinding process varies between 10⁻³ bar and 70 bar and the grain sizes between 0.5 and 20 mm.

The thermal decomposition of polymers takes place by radical splitting of their chain. A homolytic decomposition of a C—C-bond leads to radical cracked products. Homolytic means the symmetric decomposition of the duplet. The intermolecular transfer of hydrogen and the continuous decomposition of the polymeric chain create saturated and unsaturated fractions consisting of monomers and oligomers during the debinding process.

In the article forming aspect of the disclosed materials, the article is initially formed by coating particulate with an interfacial modifier. Once coated the particulate is blended with a polymer material at a packing density of at least 75 to 82 vol. % particulate to form a composite, the composite can be directly injection molded or pelletized and then injection, compression or otherwise molded into a shape. The interfacial modifier modifies surface energy, reduces particle to particle forces, reduces particle to particle interaction resulting in increased packing density. In the composite, the particulate interfacial modifier coatings on adjacent particles coalesce at each particle to particle interface. When heated to a sintering temperature (less than the melting point of any metal), substantially all polymer and organics are volatilized and removed. With minimal or no organic materials in the composite, a debinding step is often not needed. At the particle interfaces, metal from each adjacent particle and metal from the interfacial modifier diffuse into and can combine to form a sintered bond between particles or a fused mass of sintered particulate.

“Sintering is the process whereby particles bond together typically below the melting point by atomic transport events. A characteristic feature of sintering is that the rate is very sensitive to temperature. The driving force for sintering is a reduction in the system free energy, manifested by decreased surface curvatures, and an elimination of surface area” (Powder Metallurgy Science, 1989, pg. 148). The interfacial modifier on a particle surface may cooperate in the sintering process to the level of fusing with other interfacial modifier coatings on other particles to form the sintered product. The interfacial modified surfaces that fuse or sinter may be the same or different relative to the organo-metallic interfacial modifier. Further, the grain boundary, the interface between particles, may fuse or sinter as well. Sintering temperatures are about 1100-1500° C.

The steps in sintering sold body article may be summarized as follows:
1) Feedstock composite compounding of polymer and particles with IM coating.
2) molding of feedstock or composite to form a green body or a preform.
3) Sintering the green body to form the sintered part.
4) Post sintering finishing.

With minimal polymer as shown, debinding is often unneeded. If required for product specifications, inert, reducing and/or oxidizing atmospheres, applied during the appropriate stage of the sintering process, may provide useful characteristics to the final product. The gases that can be used to provide these atmospheres are argon, nitrogen (inert), hydrogen (reducing), and oxygen, air (oxidizing). If appropriate, the sintering step may occur under vacuum.

### DETAILED DESCRIPTION OF THE FIGURES

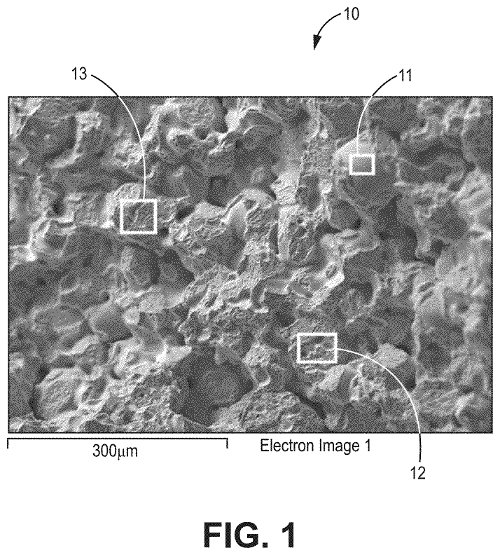

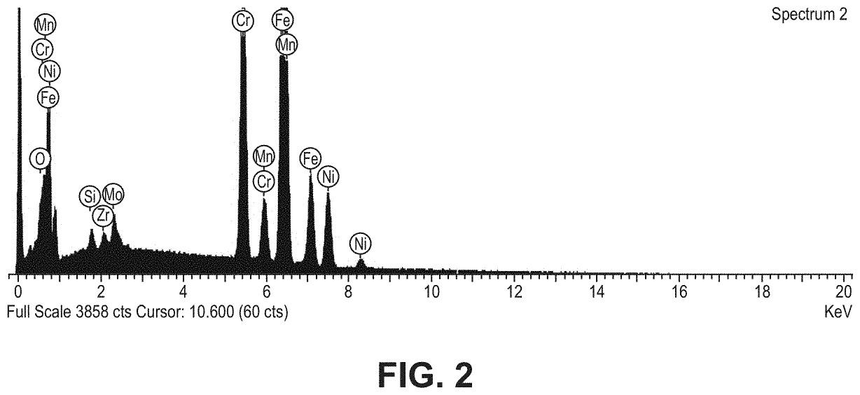

FIG. 1 shows a 100-micron x-ray fluorescent photo micrograph of a fractured surface of a sintered article wherein in fracture zone 10, shown as the dark background, reveals x-ray fluorescent images 12 of zirconium atoms in the bonding areas between adjacent particles and other areas with no zirconium detected.

FIG. 2 is an energy spectrum of the characteristic energy of the bonding Zr and each of the constituent steel atoms (O, Mn, Cr, Ni, Fe, Si, and Mo) in the sintered metal article.

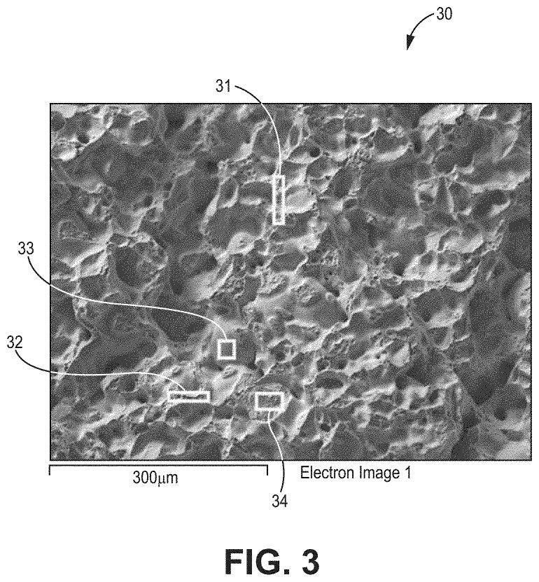

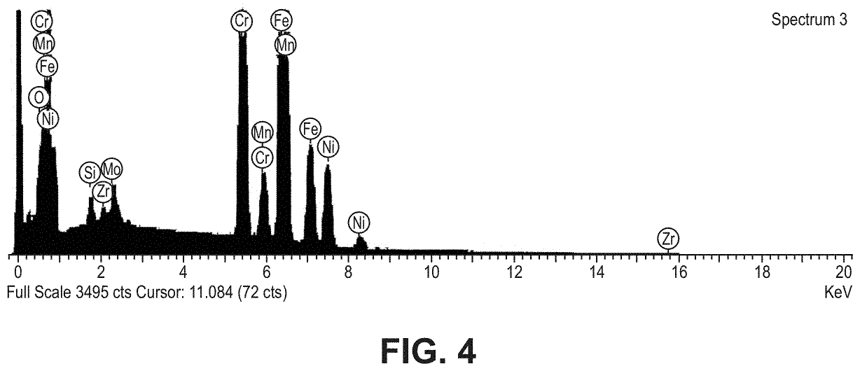

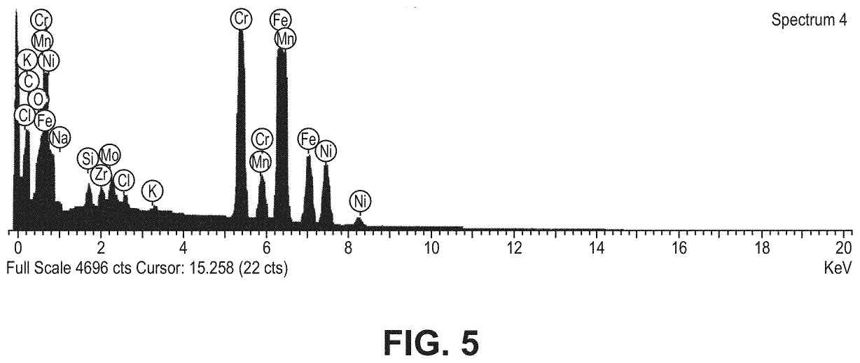

FIG. 3 is electron photo micrograph of a fracture zone showing the profile or imprint of removed metallic particles and bonding between particles in the roughened areas. In the photo micrograph of the fracture zone 30 are shown bonding areas 33 and 34, which produce emissions showing a substantial quantity of zirconium in the bond areas. Other areas 31, 32 with no emission zirconium detected.

FIGS. 4 and 5 are energy spectra of the characteristic energy of the bonding Zr and each of the constituent steel atoms (O, Mn, Cr, Ni, Fe, Si and Mo) in the sintered metal article.

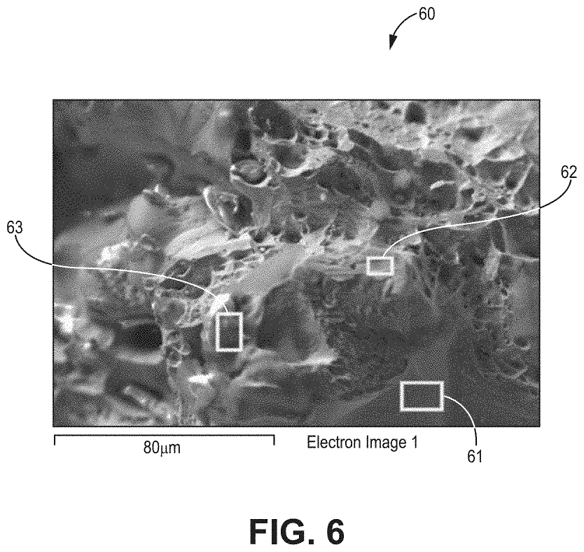

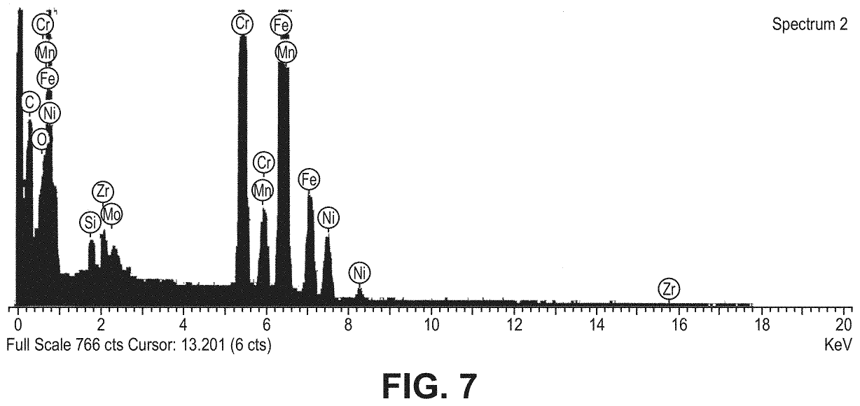

FIG. 6 is electron photo micrograph of a fracture zone showing the imprint of removed metallic particles and in the roughened areas, the bonding areas between particles. In the photo micrograph of the fracture zone 60 are shown bonding areas 62, which produce emissions showing a substantial quantity of zirconium in the bond areas. Other areas 61, 63 with no zirconium emission detected.

FIG. 7 is an energy spectrum of the characteristic energy of the bonding Zr and each of the steel constituent atoms (C, O, Mn, Cr, Ni, Fe and Mo) in the sintered metal article.

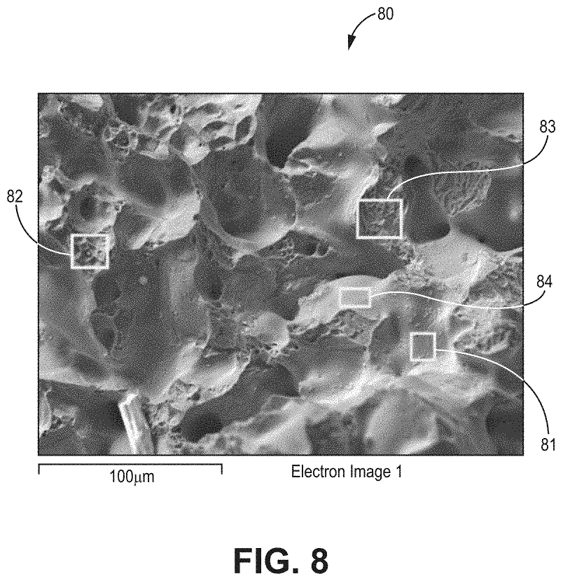

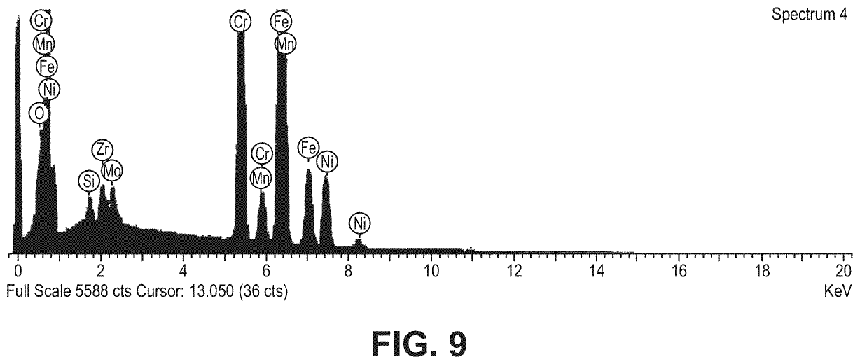

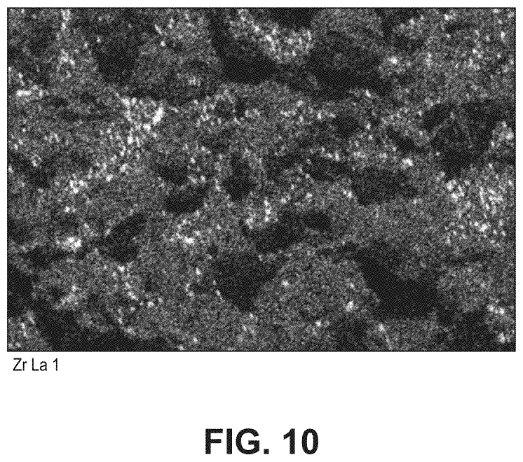

FIG. 8 is electron photo micrograph of a fracture zone showing the imprint of removed metallic particles and in the roughened areas, the bonding areas between particles. In the photo micrograph of the fracture zone 80 are shown bonding area 81, which produce emissions showing a substantial quantity of zirconium in the bond areas. Other areas 82 and 83 with no detected zirconium.

FIG. 9 is an energy spectrum of the characteristic energy of the bonding Zr and each of the constituent atoms (O, Mn, Cr, Ni, Fe, Si, and Mo) in the sintered metal article.

FIG. 10 is a high energy photo micrograph of the distribution of zirconium (Zr) atoms (white) on a fractured surface of a sintered article like that shown in FIGS. 1,3 6 and 8.

FIGS. 1-10 and the associated data (see Tables 1 and 3-6) were developed from Example 2 using energy dispersive spectroscopy (EDS) on the scanning electron microscope. The figures and data represent back scattered electron images in the scanning electron microscope display, showing a compositional contrast that results from different atomic number elements and their distribution on a surface. Energy dispersive spectroscopy (EDS) allows one to identify elements and their relative proportions (in atomic percent, for example). EDS analysis usually involves generation of an x-ray spectrum from an entire scan area of an object undergoing electron microscopy. Polished surfaces can be examined, revealing the interface between particles and the particle. The bonds between adjacent particles reveal the boron from the interfacial modifier. In a typical x-ray spectrum, the y-axis shows the intensity (number of x-rays received and processed by the detector and the x-axis shows the energy level of the peak.

The peaks represent the intensity of x-rays at specific energies emitted from specific electron transitions within target atoms. The electron energy levels are designated by the terms K, L, M, with the energies increasing from K through L, finally at M. The x-rays are produced by an atom that is energized by the kinetic contact between the atom and a high energy electron accelerated by the scanning electron microscope. The kinetic energy of the electron is transferred to an increased energy electronic orbital of the atom and that energy is then released as radiation as the electron drops from a higher orbital to a lower energy orbital. Each element showing a unique and representative energy produced by the electronic transitions within the atomic orbitals. In some greater detail, in a target atom, a hole in an orbital (a K, L, or M orbital) of a specimen atom is generated by an incident high energy electron that loses the correspondence energy E transferred through the ejected electron. The hole in the case shell is subsequently filled by an electron from an outer shell, for example, an L or M shell). The excess energy is emitted as a characteristic x-ray quantum. The unique energy of the x-ray is characteristic of the specimen atomic number from which it was derived. Accordingly, the constituent atoms in a sample can be determined and the relative proportions of the atoms can be determined within a certain level of precision. The photo micrographs are recorded, and the spectral analyses are obtained using standard machine software, of which the EDS software used is the NORAN System SIX (NSS) that is adequate and associates the energy levels of the x-rays with the elements and the electron shell levels that generated them.

TABLE 1
Reference numbers for FIGS. 1, 3, 6 and 8

| | | |
|---|---|---|
| FIG. 1 | | |
| Fractured sintered metal article | 10 | Shows the densely packed metal particles |
| | | and bond lines/areas there between |
| Representative particle to particle | 12 | Contains zirconium atoms combined with |
| bonding area | | elements of the particles in a bonding area |
| metal particle mass with no Zr | 11, 13 | Atoms detected are characteristic of metal |
| found. | | and impurities characteristic of alloy. |
| See also data Table 3-6 | | |
| FIG. 3 | | |
| Fractured sintered metal article | 30 | Shows the densely packed metal particles |
| | | and bond lines/areas there between |
| Representative particle to particle | 33, 34 | Contains zirconium atoms combined with |
| bonding area | | elements of the particles in a bonding area |
| Metal particle mass with no Zr | 31, 32 | Atoms detected are characteristic of metal |
| found. | | and impurities characteristic of alloy. |
| See also data Table 3-6 | | |
| FIG. 6 | | |
| Fractured sintered metal article | 60 | Shows the densely packed metal particles |
| | | and bond lines/areas therebetween |
| Representative particle to particle | 62 | Contains zirconium atoms combined with |
| bonding area | | elements of the particles in a bonding area |
| Metal particle mass with no Zr | 63, 61 | Atoms detected are characteristic of metal |
| found. | | and impurities characteristic of alloy. |
| See also data Table 3-6 | | |
| FIG. 8 | | |
| Fractured sintered metal article | 80 | Shows the densely packed metal particles |
| | | and bond lines/areas therebetween |
| Representative particle to particle | 81 | Contains zirconium atoms combined with |
| bonding area | | elements of the particles in a bonding area |
| Metal particle mass with no Zr | 82, 83, 84 | Atoms detected are characteristic of metal |
| found. | | and impurities characteristic of alloy. |
| See also data Table 3-6 | | |

### Example 1

### Stainless Steel

The metal particles were Carpenters 316L stainless steel (90/6<16 μm) and a special cut of Ervin ES-140 stainless steel (+150 to −106 μm). The particles were blended in a 3:1 (large: small) ratio. The raw particles were added to a lab scale mixer for about 5 minutes to obtain an evenly distributed blend. Isopropyl alcohol was added into the mix. Organo-Titanium IM CAS RN 61417-49-0, was then added at a dosage level of 1.0 wt. %. The batch was mixed and heated to about 90° C., until all IPA evaporated off the treated powder. The treated particles were compounded with TPX® DX310 (Poly methyl-pentene, Mitsui Chemicals) at 75 wt. % of treated particles.

A treated volume fraction was chosen based upon the calculated maximum loading: this volume fraction was generally lower than the calculated value. The treated particles were compounded on the 19 mm lab scale compounder with the polymer TPX® DX310 (Poly methyl-pentene, Mitsui Chemicals), a polyolefin polymer.

As an initial test, a powder disk with treated particles was pressed in a mold. A powder puck was formed by pressing the treated powders 30 times to maximum pressure on the lab jacks. The dimensions of the puck were measured to provide a comparative analysis between the sample before and after the sintering process.

Two pucks, each about 3.5 mm thick, were then made using material compounded with the TPX® DX310. Densities of each were calculated, and the pucks were placed one on top of the other. Here, the purpose was to sinter the two pieces together and calculate a new density of the sintered piece.

Upon completion of compounding, pellets were extruded on the wire line. The wire line has a 1″ extruder and a 0.075″ diameter die. The extruder contains 3 zone temperature controls within the barrel, as well as a die temperature control. The back two zone temperatures are kept well below the melting point of the polymer, which acts as a reduction of the barrel length and thus reduces the resonance time of the material at temperature. Extruded material was drawn down to a diameter of about 0.068-0.072″ and spooled up. The viscosity of this material was 43.1 Pa*s.

The sintering process occurred in a tube furnace. This furnace was purged with Nitrogen/Hydrogen gas to prevent any oxidation of the sample. The material is heated under vacuum to 1250° C., at a rate of 300° C. per hour. The furnace was then held at temperature for an hour before being cooled back to room temperature.

### Example 2

This example was made using the same procedure as example 1 except where noted. The samples for SEM analysis were made with the formulation:

TABLE 2
Test formulation

| | | | Wt. | Vol. |
|---|---|---|---|---|
| Material | | | % | % |
| Stainless steel | 316 L (Ervin) | <39 and >106 | 69.24 | 58.22 |
| | | microns | | |
| Stainless steel | 316 L (Sandvik) | D₉₀ ≥ 10 microns | 28.28 | 23.78 |
| Polypropylene | PolyOne | | 1.74 | 13.11 |
| Organo- | CAS RN | Zirconium | 0.74 | 4.89 |
| Zirconium IM | 61417-49-0 | | | |

The steel particles were coated with organo-zirconium and compounded, and then injection molded into an ASTM type IV dogbone in a Gluco vertical injection mold. Sample was pre-conditioned in a high convection oven at 135° C. for 24 hours, then sintered in a 2″ tube furnace. The initial temperature was 135° C. and ramped over 6 hours to a peak temperature of 1404° C. in a hydrogen atmosphere. The following tables show the SEM element data from the particles and bond line in the cut face. This data is derived from the samples seen in FIGS. 1-10

TABLE 3
Zr bond data FIG. 1 and 2 (Some elements
not shown - results in wt. %)

| Spectrum | O | Cr | Mn | Fe | Ni | Zr | Mo |
|---|---|---|---|---|---|---|---|
| Spectrum 11 | | 17.68 | 1.61 | 65.31 | 11.94 | | 2.64 |
| Spectrum 12 | 1.22 | 19.46 | 1.76 | 62.67 | 10.88 | 1.12 | 2.28 |
| Spectrum 13 | | 19.05 | 1.81 | 63.72 | 11.44 | | 2.70 |
| Max. | 1.22 | 19.46 | 1.81 | 65.31 | 11.94 | 1.12 | 2.70 |
| Min. | 1.22 | 17.68 | 1.61 | 62.67 | 10.88 | 1.12 | 2.28 |

TABLE 4
Zr bond data FIG. 3-5

| Spectrum | C | Cr | Mn | Fe | Ni | Zr | Mo |
|---|---|---|---|---|---|---|---|
| Spectrum 33 | | 18.56 | 1.90 | 64.38 | 10.87 | | 1.97 |
| Spectrum 34 | | 24.35 | 1.32 | 60.66 | 4.91 | | 7.49 |
| Spectrum 31 | | 18.34 | 1.66 | 63.50 | 10.70 | 1.17 | 2.55 |
| Spectrum 32 | 15.50 | 14.89 | 1.40 | 51.44 | 8.88 | 1.41 | 2.12 |
| Max. | 15.50 | 24.35 | 1.90 | 64.38 | 10.87 | 1.41 | 7.49 |
| Min. | 15.50 | 14.89 | 1.32 | 51.44 | 4.91 | 1.17 | 1.97 |

TABLE 5
Zr bond data FIG. 6 and 7

| Spectrum | Cr | Mn | Fe | Ni | Zr | Mo |
|---|---|---|---|---|---|---|
| Spectrum 62 | 4.32 | | 12.00 | 1.55 | | 6.60 |
| Spectrum 61 | 17.70 | 1.82 | 47.15 | 6.69 | 2.11 | 1.58 |
| Spectrum 63 | 14.92 | 1.15 | 54.68 | 10.48 | | 2.52 |
| Max. | 17.70 | 1.82 | 54.68 | 10.48 | 2.11 | 6.60 |
| Min. | 4.32 | 1.15 | 12.00 | 1.55 | 2.11 | 1.58 |

TABLE 6
Zr bond data FIG. 8 and 9

| Spectrum | Cr | Mn | Fe | Ni | Zr | Mo |
|---|---|---|---|---|---|---|
| Spectrum 82 | 16.00 | 1.53 | 55.95 | 10.11 | | 2.46 |
| Spectrum 83 | 19.33 | 1.85 | 64.31 | 11.09 | | 2.65 |
| Spectrum 84 | 17.59 | 1.67 | 63.98 | 12.26 | | 3.41 |
| Spectrum 81 | 18.48 | 1.52 | 59.97 | 11.30 | 3.12 | 2.83 |
| Max. | 19.33 | 1.85 | 64.31 | 12.26 | 3.12 | 3.41 |
| Min. | 16.00 | 1.52 | 55.95 | 10.11 | 3.12 | 2.46 |

These data were developed from Example 3 using energy dispersive spectroscopy (EDS) on the scanning electron microscope. The figures and data represent back scattered electron images in the scanning electron microscope display, showing a compositional contrast that results from different atomic number elements and their distribution on a surface. Energy dispersive spectroscopy (EDS) allows one to identify elements and their relative proportions (in atomic percent, for example). EDS analysis usually involves generation of an x-ray spectrum from an entire scan area of an object undergoing electron microscopy. Polished surfaces can be examined, revealing the interface between particles and the particle. The bonds between adjacent particles reveal the boron from the interfacial modifier. In a typical x-ray spectrum, the y-axis shows the intensity (number of x-rays received and processed by the detector and the x-axis shows the energy level of the peak.

The peaks represent the intensity of x-rays at specific energies emitted from specific electron transitions within target atoms. The electron energy levels are designated by the terms K, L, M, with the energies increasing from K through L, finally at M. The x-rays are produced by an atom that is energized by the kinetic contact between the atom and a high energy electron accelerated by the scanning electron microscope. The kinetic energy of the electron is transferred to an increased energy electronic orbital of the atom and that energy is then released as radiation as the electron drops from a higher orbital to a lower energy orbital. Each element showing a unique and representative energy produced by the electronic transitions within the atomic orbitals. In some greater detail, in a target atom, a hole in an orbital (a K, L, or M orbital) of a specimen atom is generated by an incident high energy electron that loses the correspondence energy E transferred through the ejected electron. The hole in the case shell is subsequently filled by an electron from an outer shell, for example, an L or M shell). The excess energy is emitted as a characteristic x-ray quantum. The unique energy of the x-ray is characteristic of the specimen atomic number from which it was derived. Accordingly, the constituent atoms in a sample can be determined and the relative proportions of the atoms can be determined within a certain level of precision. The photo micrographs are recorded, and the spectral analyses are obtained using standard machine software, of which the EDS software used is the NORAN System SIX (NSS) that is adequate and associates the energy levels of the x-rays with the elements and the electron shell levels that generated them.

Samples for EDM spectroscopy using SEM were prepared by taking sintered bar or paddle and cooling it to liquid nitrogen temperature and then shattering the cooled sample with a sharp blow. We observed that the resulting exposed surfaces were representative of the particle surfaces and areas from which the particles were removed. In such exposed surfaces, the presence of the Zr or Ti or other atoms typical of steel, is evidence of a bond containing metal from the particulate and the IM. Note that samples prepared by slicing and polishing the sintered bar or paddle did not show detectable Zr.

### Example 3

### Stainless Steel

Substantially using the procedure of Example 1 the following materials were compounded and made into dog bones.

TABLE 7
Compositions

| | | Relevant | Wt. | Wt. | Vol. |
|---|---|---|---|---|---|
| Material | Component | characteristic | (grams) | % | % |
| Polymer | Polypropylene | s.g. = 0.912 | | 2.450 | 17.291 |
| | PolyOne | | | | |
| Particle ₁ | 316 L Stainless | Less than | | 72.614 | 58.500 |
| | steel particulate | 125μ D₅₀ = | | | |
| | | 70μ | | | |
| Particle ₂ | 316 L Stainless | D₉₀ < 22μ | | 6.051 | 4.875 |
| | Steel Particulate | | | | |
| Particle ₃ | 316 L Stainless | D₉₀ < 10μ | | 18.154 | 14.625 |
| | Steel Particulate | | | | |
| Interfacial | Organo titanium | | 28 | 0.732 | 4.710 |
| modifier | compound | | | | |
| Particle | | | | | 78.00 |
| Packing | | | | | |
| fraction | | | | | |
| | | | | %'s based | %'s based |
| | | | | on | on |
| | | | | composition | composition |

We produced 10 sintered dog-bones (five iterations, at two dog-bones per iteration) in sintering tube furnace (in hood). The injection molded dog bones after sintering had good properties. A statistical validation/significance with two samples was obtained.

TABLE 8
Sintering Conditions

| | Temp. ^{°} C. | Time (mm) |
|---|---|---|
| 1 | 50 | 300 (+1.33 C./min) |
| 2 | 450 | 60 |
| 3 | 450 | 112 (+1.33 C./min) |
| 4 | 600 | 60 |
| 5 | 600 | 409 (+2.00 C./min) |
| 6 | 1417 | 90 |
| 7 | 1417 | 290 (−4.71 C./min) |
| 8 | 50 | −121 |

The sintered test dog bones were measured for loss in weight and dimension. The data are shown in the following table.

TABLE 9
Loss Upon Sintering

| | Mass | Length | Width | Thickness | width | Thickness |
|---|---|---|---|---|---|---|
| Ex. 1a | g | mm | mm | mm | mm | mm |
| Initial | 31.7424 | 114.90 | 18.90 | 3.30 | 18.91 | 3.36 |
| Final | 30.8566 | 108.21 | 18.12 | 3.18 | 18.06 | 3.22 |
| Δ (loss) | 0.8858 | 6.69 | 0.78 | 0.12 | 0.85 | 0.14 |
| %Δ (loss) | 2.79 | 5.82 | 4.13 | 3.64 | 4.49 | 4.17 |
| | Mass | Length | Width | Thickness | width | Thickness |
| Ex. 1b | G | mm | mm | mm | mm | mm |
| Initial | 31.6074 | 114.79 | 18.86 | 3.28 | 18.92 | 3.34 |
| Final | 30.7117 | 108.46 | 17.82 | 3.11 | 18.06 | 3.23 |
| Δ (loss) | 0.8957 | 6.33 | 1.04 | 0.17 | 0.86 | 0.11 |
| %Δ (loss) | 2.83 | 5.51 | 5.51 | 5.18 | 4.55 | 3.29 |

In summary, the composites, as dictated by the specific claims contained herein, represents a breadth of raw material combinations including; metals, inorganic particles, ceramic particles, glass bubble particles, polymers, interfacial modifiers, other additives, all with varying particle sizes, weight fractions, and volume fractions. The present embodiment also includes a breadth of processing methods, such as sintering and densification, resulting physical and chemical properties, and end-use applications.

The complete disclosure of all patents, patent applications, and publications cited herein are incorporated by reference. If any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not to be limited to the exact details shown and described, for variations obvious to one skilled in the art will be included within the disclosure defined by the claims.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed considering the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

While the above specification shows an enabling disclosure of the composite technology of the disclosure, other embodiments may be made without departing from the spirit and scope of the claimed technology. Accordingly, the disclosed technology is embodied in the claims hereinafter appended. While the above specification shows an enabling disclosure of the composite technology of the system, other embodiments of the system components may be made without departing from the spirit and scope of the claimed subject matter.

1-27. (canceled)

28. A method comprising:
(i) forming a powdered composition consisting essentially of:
(a) a metal particulate having a surface and a particle size of 1 to 300 microns; and
(b) a metallic coating on the particle surface comprising an organo metallic coating of about 0.1 to 2 wt. % of an interfacial modifier based on the composition;
(ii) compressing the powdered composition to form a green body; and
(iii) sintering the green body;
wherein each particle surface is bonded to at least one adjacent particle surface with a bond that comprises at least one element from each particle and at least one element derived from the interfacial modifier, and wherein an article is formed has a packing density greater than 70%.

29. The method of claim 28 wherein the interfacial modifier comprises atoms of titanium, boron, aluminum, silicon, strontium, neodymium, yttrium, zirconium, or mixtures thereof.

30. The method of claim 28 wherein the metal particulate is a ferrous metal or a ferrous alloy.

31. The method of claim 30 wherein the ferrous alloy is a magnetic stainless steel.

32. The method of claim 28 wherein the metal particulate is a copper metal, a nickel metal, a tungsten metal, a molybdenum metal, or an alloy thereof.

33. The method of claim 28 wherein the metal particulate has an excluded volume of about 5 to 22 vol. %

34. The method of claim 28 wherein the metal particulate comprises at least two different metals.

35. An article comprising:
(i) a sintered composition consisting essentially of:
(a) a metal particulate having a surface and a particle size of 1 to 300 microns; and
(b) a metallic coating on the particle surface comprising a an organo metallic coating of about 0.1 to 2 wt. % of an interfacial modifier;
wherein each particle surface is bonded to at least one adjacent particle surface with a bond that comprises at least one element from each particle and at least one element derived from the interfacial modifier, and wherein an article is formed has a packing density greater than 70%.

36. The article of claim 35 wherein the interfacial modifier comprises atoms of titanium, boron, aluminum, silicon, strontium, neodymium, yttrium, zirconium, or mixtures thereof.

37. The article of claim 35 wherein the metal particulate is a ferrous metal or a ferrous alloy.

38. The article of claim 37 wherein the ferrous alloy is a magnetic stainless steel.

39. The article of claim 35 wherein the metal particulate is a copper metal, a nickel metal, a tungsten metal, a molybdenum metal, or an alloy thereof.

40. The article of claim 35 wherein the metal particulate has an excluded volume of about 5 to 22 vol. %

41. The article of claim 35 wherein the metal particulate comprises at least two different metals.

42. A sintered article formed by steel powder metallurgy comprising:
(i) a steel particulate including a particle having a surface and a particle size of 1 to 300 microns; and
(ii) a titanium or zirconium coating on the particle surface derived from an interfacial modifier coating; and wherein each particle is bonded to at least one adjacent particle with a bond that comprises at least one element from each particle and at least one titanium or zirconium element derived from the interfacial modifier, and wherein the article has a packing density greater than 70%.

43. The article of claim 42 wherein the article is substantially free of an internal void space and has a dimension greater than 15 cm.

44. The article of claim 42 wherein the particulate is a magnetic steel particulate.

45. The article of claim 42 wherein the particulate is a blend of two steel particulates.

46. The article of claim 42 wherein the interfacial modifier coating has a thickness of about 1-500 Å and the article has a complex form.
